(19) United States
(12) Patent Application Publication
(10) Pub. No.: US 2016/0348793 A1
(43) Pub. Date: Dec. 1, 2016

(54) KNIFE GATE VALVE AND SEAL

(71) Applicant: DeZURIK, Inc., Sartell, MN (US)

(72) Inventor: Jayashree Patel, Cambridge (CA)

(21) Appl. No.: 15/167,578

(22) Filed: May 27, 2016

Related U.S. Application Data
(60) Provisional application No. 62/167,095, filed on May 27, 2015.

(51) Int. Cl. F16K 3/02

(52) U.S. Cl. CPC F16K 3/0227; F16K 3/0272; F16K 3/0281

(57) ABSTRACT

Embodiments include a seal for a knife gate valve. The seal includes a seal body that comprises a top surface and a bottom surface, an inner surface of the seal body defines a gate aperture extending from the top surface to the bottom surface; and an insert disposed within the seal body, wherein the insert extends around at least a portion of the gate aperture and the insert is more rigid than the seal body; wherein an inner surface is nonlinear with at least one projection and at least one trough. Further embodiments include a knife gate valve. The knife gate valve can include a valve body that defines a flow aperture, the valve body configured to be coupled to a conduit; a gate disposed at least partially within the valve body and a seal disposed on top of the valve body. Other embodiments are also included herein.

This application is a non-provisional application claiming priority to U.S. Provisional Application No. 62/167,095, filed May 27, 2015, and the entire contents are incorporated herein by reference.

### FIELD OF THE TECHNOLOGY

The present application relates to a knife gate valve and a seal for a knife gate valve. More specifically, the present application relates to the positioning of a seal with a knife gate valve and to the shape of the seal.

### BACKGROUND

Knife gate valves are often used as isolation or shut-off valves. A knife gate valve is often intended to shut-off flow without regard to the direction of flow or the direction in which pressure is applied relative to the valve.

Most knife gate valves include a seal. The seal is often positioned within the body of the valve. The seal is intended to prevent the fluid flowing through the conduit from leaking through the area in which the gate moves through when the gate is moving from an open position to a closed position. The seal can wear out over time and needs to be replaced. Replacement of the seal often involves disassembly of the valve body.

Accordingly, there is a need for seal that is more easily replaced and a seal that more substantially prevents fluid from leaking.

### SUMMARY

Embodiments disclosed herein include a seal for a knife gate valve, such as a slurry knife gate valve. In various embodiments, the seal can include a seal body that comprises a top surface and a bottom surface, an inner surface of the seal body defines a gate aperture extending from the top surface to the bottom surface; and an insert disposed within the seal body, wherein the insert extends around at least a portion of the gate aperture and the insert is more rigid than the seal body; wherein inner surface is nonlinear with at least one projection and at least one trough.

In an embodiment, the seal body defines at least one connector location.

In an embodiment, the seal body and insert define at least one connector location.

In an embodiment, the insert is completely surrounded by the seal body except for at any connector locations.

In an embodiment, over 90% of the insert is surrounded by the seal body.

In an embodiment, the insert comprises metal and the seal body comprises rubber or a polymer.

In an embodiment, the at least one trough is positioned between two projections.

In an embodiment, the trough is centered between the top surface and the bottom surface.

In an embodiment, the seal body is a rectangular prism.

In an embodiment, the inner surface exhibits a sinusoidal shape.

Embodiments disclosed herein include a knife gate valve that includes a valve body that defines a flow aperture, the valve body is configured to be coupled to a conduit; a gate disposed at least partially within the valve body, the gate configured to be moved vertically in relation to the valve body from a lowered position to a raised position, wherein when the gate is in a lowered position the gate substantially terminates flow through the flow aperture and when the gate is in a raised position flow is permitted through the flow aperture; a seal disposed on top of the valve body; the seal includes a top surface and a bottom surface, an inner surface of the seal body defines a gate aperture extending from the top surface to the bottom surface; and an insert disposed within the seal body, wherein the insert extends around at least a portion of the gate aperture and the insert is more rigid than the seal body; wherein at least a portion of the gate moves through the gate aperture when the gate is moved from the raised position to the lowered position or from the lowered position to the raised position.

In an embodiment, the inner surface is nonlinear with at least one projection and at least one trough.

Embodiments disclosed herein include a knife gate valve that includes a valve body that defines a flow aperture, the valve body configured to be coupled to a conduit; a gate disposed at least partially within the valve body, the gate configured to be moved vertically in relation to the valve body from a lowered position to a raised position, wherein when the gate is in a lowered position the gate substantially terminates flow through the flow aperture and when the gate is in a raised position flow is permitted through the flow aperture; a seal coupled to the valve body, wherein the seal includes a seal body that comprises a top surface and a bottom surface, an inner surface of the seal body defines a gate aperture extending from the top surface to the bottom surface; and an insert disposed within the seal body, wherein the insert extends around at least a portion of the gate aperture and the insert is more rigid than the seal body; wherein inner surface is nonlinear with at least one projection and at least one trough; wherein at least a portion of the gate moves through the gate aperture when the gate is moved from the raised position to the lowered position or from the lowered position to the raised position.

In an embodiment, the seal is disposed on a top portion of the valve body.

Embodiments include a knife gate valve comprising a valve body that defines a flow aperture, the valve body configured to be coupled to a conduit; a gate disposed at least partially within the valve body, the gate configured to be moved vertically in relation to the valve body from a lowered position to a raised position, wherein when the gate is in a lowered position the gate substantially terminates flow through the flow aperture and when the gate is in a raised position flow is permitted through the flow aperture; a flexible seal coupled to the valve body, wherein flexible the seal comprises: a seal body that comprises a substantially flat top surface, a substantially flat bottom surface, and an inner surface that a gate aperture extending from the top surface to the bottom surface; and a metallic insert disposed within the flexible seal body, wherein the metallic insert extends around at least a portion of the gate aperture but does not form the gate aperture, and the insert is more rigid than the seal body; wherein a cross section of the inner surface taken from the top to the bottom of the seal body has a non-linear contact with at least one projection and at least one trough such that the open area defined by the inner surface is greater intermediate the top surface and bottom surface than it is intermediate the top and bottom surface; wherein at least a portion of the gate moves through the gate aperture when the gate is moved from the raised position to the lowered position or from the lowered position to the raised position; wherein the insert is completely surrounded by the flexible seal body except for at any connector locations on the top surface of the seal body; and wherein over 90% of the insert is surrounded by the flexible seal body.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present application is defined by the appended claims and their legal equivalents.

### BRIEF DESCRIPTION OF THE FIGURES

The technology may be more completely understood in connection with the following drawings, in which:

FIG. 1 is a perspective view of a closed knife gate valve, according to an embodiment.

FIG. 2 is a perspective view of the knife gate valve of FIG. 1 opened.

FIG. 3 is a perspective view of a closed knife gate valve, according to an embodiment.

FIG. 4 is a perspective view of the knife gate valve of FIG. 3 open.

FIG. 5 is a partially exploded view of the knife gate valve shown in FIGS. 3 and 4.

FIG. 6 is a partially exploded view of the knife gate valve shown in FIGS. 3 and 4 without the gate.

FIG. 7 is a perspective view of a seal, according to an embodiment.

FIG. 8 is a top view of a seal, according to an embodiment.

FIG. 9 is a side view of a seal, according to an embodiment.

FIG. 10 is a cross section view of a seal, according to an embodiment.

FIG. 11 is a cross section view of a seal, according to an embodiment.

FIG. 12 is a perspective view of an insert, according to an embodiment.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Embodiments include a knife gate valve comprising a valve body that defines a flow aperture, the valve body configured to be coupled to a conduit; a gate disposed at least partially within the valve body, the gate configured to be moved vertically in relation to the valve body from a lowered position to a raised position, wherein when the gate is in a lowered position the gate substantially terminates flow through the flow aperture and when the gate is in a raised position flow is permitted through the flow aperture; a flexible seal coupled to the valve body, wherein flexible the seal comprises: a seal body that comprises a substantially flat top surface, a substantially flat bottom surface, and an inner surface that a gate aperture extending from the top surface to the bottom surface; and a metallic insert disposed within the flexible seal body, wherein the metallic insert extends around at least a portion of the gate aperture but does not form the gate aperture, and the insert is more rigid than the seal body; wherein a cross section of the inner surface taken from the top to the bottom of the seal body has a non-linear contact with at least one projection and at least one trough such that the open area defined by the inner surface is greater intermediate the top surface and bottom surface than it is intermediate the top and bottom surface; wherein at least a portion of the gate moves through the gate aperture when the gate is moved from the raised position to the lowered position or from the lowered position to the raised position; wherein the insert is completely surrounded by the flexible seal body except for at any connector locations on the top surface of the seal body; and wherein over 90% of the insert is surrounded by the flexible seal body.

Knife gate valves can be used as shut off valves for a portion of piping or conduit. Knife gate valves include a gate that can be slid or moved perpendicular to the flow of fluid through the valve. The gate can be moved into a position where the gate substantially terminates flow through the valve, such as by occupying the flow aperture that allows fluid to flow through the valve. The gate can be moved into a position where the gate does not occupy any portion of the flow aperture, such as to permit fluid to flow through the valve.

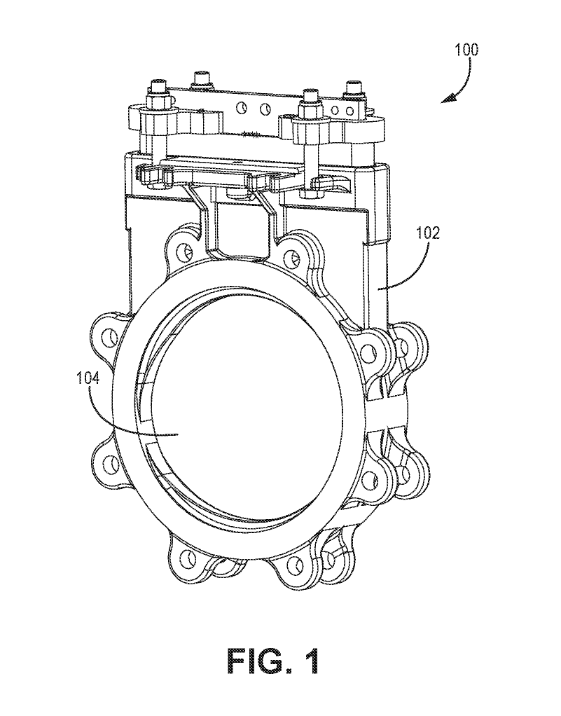

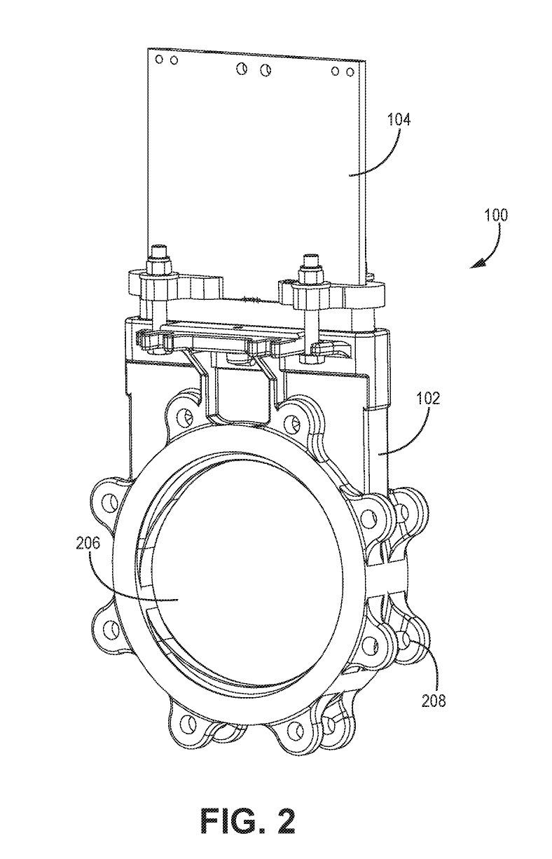

FIG. 1 shows a perspective view of a knife gate valve 100, according to an embodiment. The knife gate valve 100 can be bidirectional, such that flow through the valve can be in either direction. The knife gate valve 100 can include a valve body 102, such as the body of the valve 100 that additional components can be coupled to. The valve body 102 can define a flow aperture (shown in FIG. 2) configured to allow the passage of fluids through the valve 100.

The knife gate valve 100 can include a gate 104, such as substantially planar element that can be moved an axis (such as a vertical axis) with respect to the valve body 102. The gate 104 can be at least partially disposed within the valve body 102. The gate 104 can be moved vertically with respect to the body 102, such as to open or close the flow aperture. In an embodiment, more of the gate 104 is disposed within the body 102 when the gate 104 is in a closed position compared to when the gate 104 is in an open position. The valve body 102 can be configured to be coupled to a conduit or a pipe, such as to accommodate flow through the pipe and the valve 100 when the gate 104 is in an open position, or to substantially terminate flow through the pipe with the gate 104 is in a close position.

FIG. 2 shows a perspective view of a knife gate valve 100 with the gate 104 in an open position. The valve body 102 can define a flow aperture 206. When the gate 104 is in an open position, the gate 104 can be substantially clear or free of the flow aperture 206, such as to allow fluids to flow through the valve 100. When the gate 104 is in a closed position, the gate 104 can substantially block the flow aperture 206, such as to substantially terminate the flow of fluids through the valve 100. The gate 104 can substantially terminate the flow through the valve 100, such that only negligible amounts of fluid are able to seep through areas between the valve body 102, the gate 104 and any associated seals.

The valve body 102 can define one or more connection elements 208, such as to couple the valve body 102 to a pipe or conduit. The connection elements 208 can include apertures, such as for a bolt or an alternative connector to extend through. The connection elements 208 can be monolithic with the valve body 102.

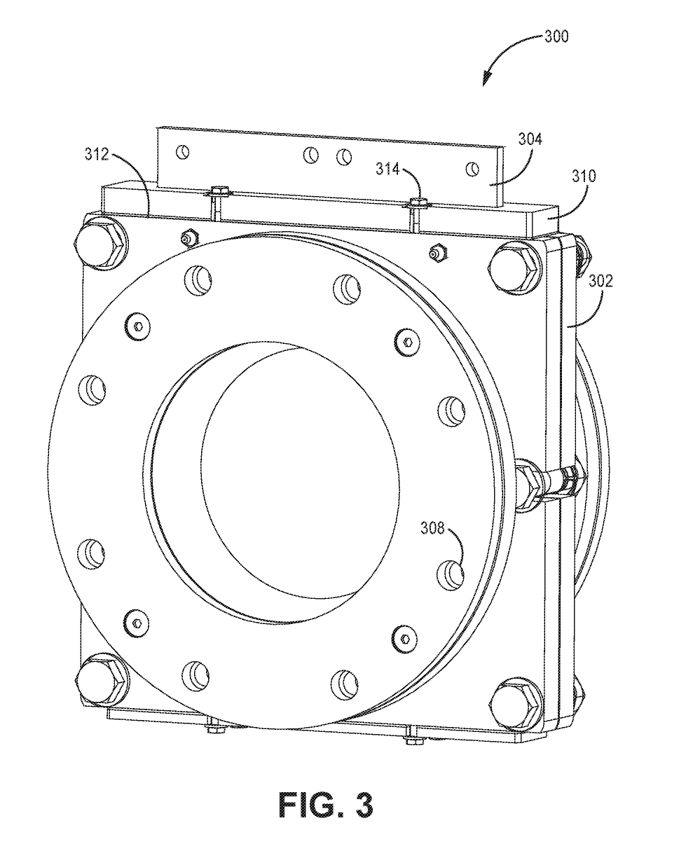

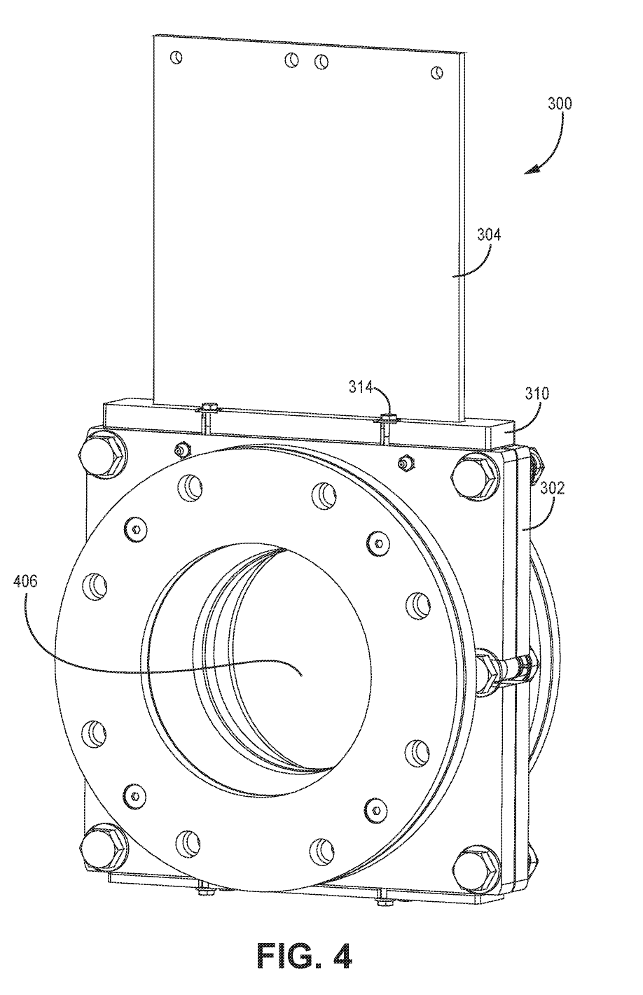

FIG. 3 is a perspective view of a closed knife gate valve 300, according to an embodiment. FIG. 4 shows a perspective view of the knife gate valve 300 shown in FIG. 3 in an open configuration.

As discussed above, the valve 300 can include a valve body 302. The valve 300 can include a gate 304. The valve body 302 can define a flow aperture 406. The valve body 302 can include one or more connection elements 308.

In an embodiment, the valve 300 can include a seal 310, such as a seal 310 that is external from the valve body 302. The seal 310 can be coupled to the valve body 102, such as with connectors 314. The seal 310 can be external from the valve body 302, such that the seal 310 is disposed on and/or coupled to an external surface of the valve body 302. The seal 310 can be external from the valve body 302, such that greater than 50% of the surface area of the seal 310 is viewable (not covered by the valve body 302 or within the valve body 302). In other embodiments, at least five of six outer surfaces of the seal 310 can be visible.

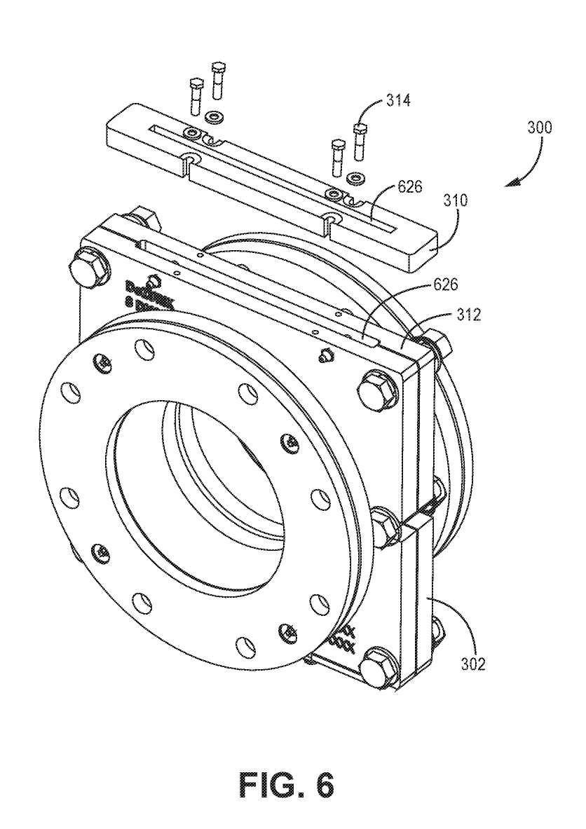

The seal 310 can be configured to at least partially inhibit or prevent the flow of fluid from the flow aperture through the gate aperture (shown in FIG. 6). The valve body 302 and the seal 310 can define a gate aperture. The gate 304 can be at least partially disposed within the gate aperture. The gate 304 can move at least partially through the gate aperture, such as when opening or closing the flow aperture. In an embodiment, the gate aperture can be perpendicular to the flow aperture 406.

In various embodiments, the valve body 302 can generally define a rectangular prism, such as having six rectangular surfaces. The valve body 302 can include a top surface 312. The top surface 312 can be planar or flat, such as to match the shape of the surface of the seal that the top surface 312 interfaces with.

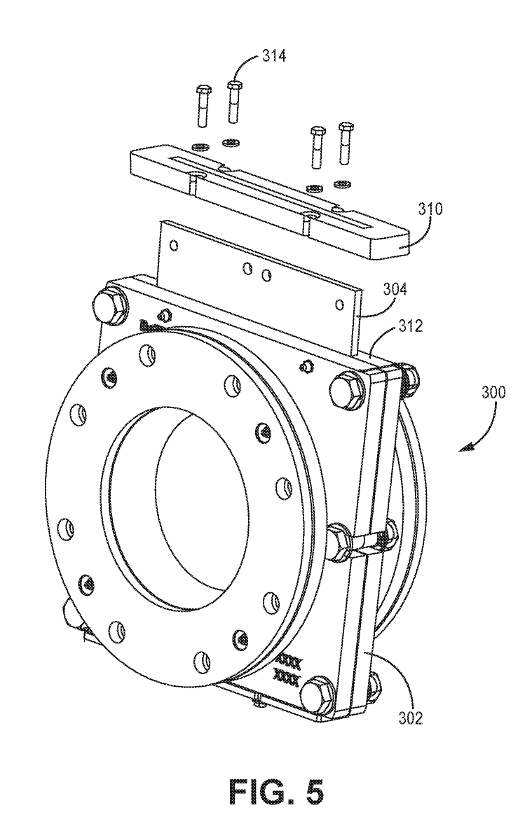

FIG. 5 is a partially exploded view of the knife gate valve 300 shown in FIGS. 3 and 4. FIG. 6 shows a partially exploded valve 300 as shown in FIG. 5 with the gate 304 removed. The seal 310 can be coupled to the valve body 302 with a plurality of connectors 314. In various embodiments, the seal 310 can be disposed on the top surface 312 of the valve body. In an embodiment, the top surface 312 refers to an outer or external surface that defines an aperture that the gate 304 slides at least partially through. The top surface 312 can refer to a surface that is on the bottom or the side when the valve 300 is coupled to a conduit or pipe.

In an embodiment, the seal 310 and the valve body 302 can define a gate aperture 626. The gate aperture 626 can be configured to allow the gate 304 to move through or with respect to the seal 310 or the valve body 302. The gate aperture 626 can be configured to accommodate the gate 304, such as by having a shape similar to the cross-section of the gate 304.

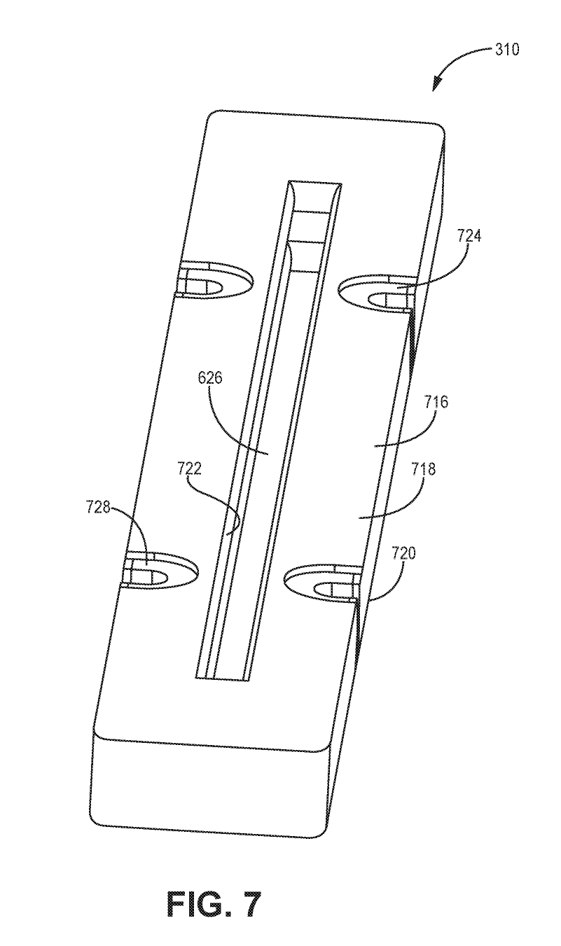

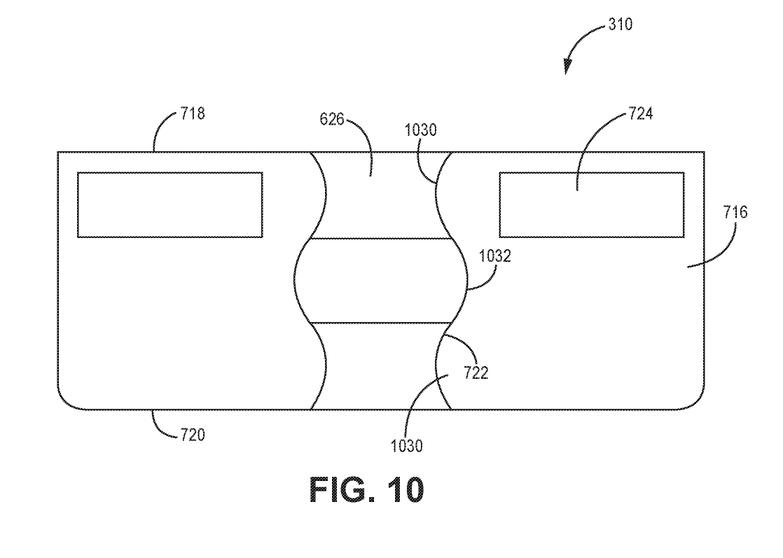

FIG. 7 is a perspective view of a seal 310, according to an embodiment. The seal 310 can include a seal body 716 and an insert (shown in FIGS. 10-12). The seal body 716 can generally define a rectangular prism, such as by having six substantially rectangular surfaces. In various embodiments, the substantially rectangular surfaces can have curved or rounded corners, such as shown in FIG. 7. In various embodiments, the seal body 716 can include a rubber or polymer, such as EPDM and HNBR.

In various embodiments, the seal body 716 can include a top surface 718 and a bottom surface 720. The seal 310 can define a portion of the gate aperture 626. The portion of the gate aperture 626 that is defined by the seal can extend from and through the top surface 718 to the bottom surface 720.

The seal 310 can include an insert 724. In an embodiment, the insert 724 can include metal, such as aluminum or stainless steel. In various embodiments, the majority of the insert 724 can be disposed of within seal body 716. The insert 724 can be more rigid than the seal body 716, such as the insert 724 is more resistant to being deformed (elastically or inelastically). In an embodiment, the insert 724 can require more force to be deformed than the seal body 716.

In an embodiment, the entire insert 724 is covered or surrounded by the seal body 716, such that none of the insert 724 is visible. In an embodiment, the entire insert 724 is covered or surround by the seal body 716, except at the connector locations 728, such as shown in FIG. 7. In an embodiment, at least 95% of the surface area of the insert 724 is covered by the seal body 716. In an embodiment, at least 90% of the surface area of the insert 724 is covered by the seal body 716. In an embodiment, at least 75% of the surface area of the insert 724 is covered by the seal body 716. In an embodiment, at least 50% of the surface area of the insert 724 is covered by the seal body 716.

In various embodiments, the insert 724 can extend around at least a portion of the gate aperture 626, such as the gate aperture 626 extends through the insert 724. In an embodiment, the gate aperture 626 extends through the insert 724, such as the insert circles or surrounds a portion of the gate aperture 626. In various embodiments, a portion of the seal body 716 can separate the insert 724 from the gate aperture 626.

In various embodiments, the seal body 716 and/or the insert 724 can define one or more connector locations 728, such as where connectors 314 are located to couple the seal 310 to the valve body 302. In various embodiments, a portion of the insert 724 can be exposed at the connector locations 728.

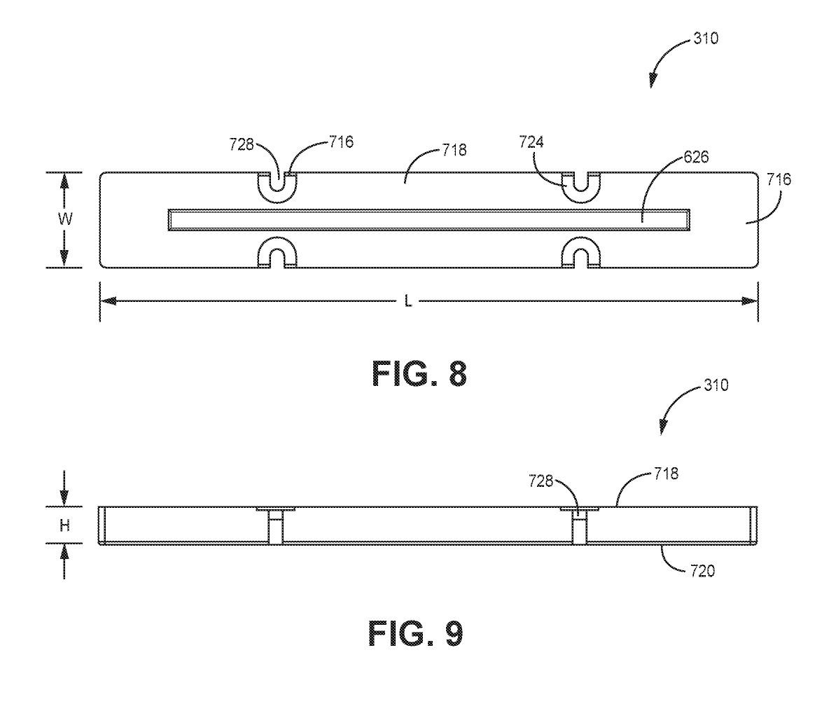

FIG. 8 is a top view of a seal 310, according to an embodiment. The seal 310 can define one or more connector locations 728. The connector locations 728 can be configured to accommodate the connectors 314. In an embodiment, the connector locations 728 can be recesses in the seal 310. The connector locations 728 can include a plateau or recessed surface, such as to match the shape of a bolt. In an embodiment, there can be two connector locations 728 on each side of the seal 310. In an embodiment, a portion of the insert 724 can be exposed at a connector location 728, such as at a plateau or recessed surface.

In an embodiment, the seal 310 can have a length L of about 13 inches. In an embodiment, the seal 310 can have a length of at least 12 inches and not more than 14 inches. In an embodiment, the seal 310 can have a length of at least 10 inches and not more than 15 inches. In an embodiment, the seal 310 can have a length of at least 8 inches and not more than 17 inches. In an embodiment, the seal 310 can have a length of at least 6 inches and not more than 20 inches. In an embodiment, the seal 310 can have a length of at least 6 inches and not more than 30 inches. In an embodiment, the seal 310 can have a width W of about 1.5 inches. In an embodiment, the seal 310 can have a width of at least 1.25 inches and not more than 1.75 inches. In an embodiment, the seal 310 can have a width of at least 1 inch and not more than 2 inches. In an embodiment, the seal 310 can have a width of at least 0.75 inches and not more than 2.25 inches. In an embodiment, the seal 310 can have a width of at least 0.5 inches and not more than 5 inches.

In an embodiment, the gate aperture 626 can have a length of about 10.2 inches. In an embodiment, the gate aperture 626 can have a length of at least 10 inches and not more than 11 inches. In an embodiment, the gate aperture 626 can have a length of at least 8 inches and not more than 13 inches. In an embodiment, the gate aperture 626 can have a length of at least 6 inches and not more than 15 inches.

In an embodiment, the gate aperture 626 can have a length of at least 5 inches and not more than 20 inches. In an embodiment, the gate aperture 626 can have a length of at least 5 inches and not more than 30 inches.

In an embodiment, the gate aperture 626 can have a width of about 0.31 inches. In an embodiment, the gate aperture 626 can have a width of at least 0.3 inches and not more than 0.35 inches. In an embodiment, the gate aperture 626 can have a width of at least 0.25 inches and not more than 0.5 inches. In an embodiment, the gate aperture 626 can have a width of at least 0.15 inches and not more than 0.75 inches. In an embodiment, the gate aperture 626 can have a width of at least 0.15 inches and not more than 1 inch. In an embodiment, the gate aperture 626 can have a width of at least 0.15 inches and not more than 2 inches. In an embodiment, the gate aperture 626 can have a width of at least 0.15 inches and not more than 3 inches.

FIG. 9 is a side view of a seal 310, according to an embodiment. In an embodiment, the seal 310 can have a height h of about 0.75 inches. In an embodiment, the seal 310 can have a height of at least 0.7 inches and not more than 0.8 inches. In an embodiment, the seal 310 can have a height of at least 0.6 inches and not more than 0.9 inches. In an embodiment, the seal 310 can have a height of at least 0.5 inches and not more than 1 inch. In an embodiment, the seal 310 can have a height of at least 0.5 inches and not more than 1.5 inches. In an embodiment, the seal 310 can have a height of at least 0.5 inches and not more than 2 inches.

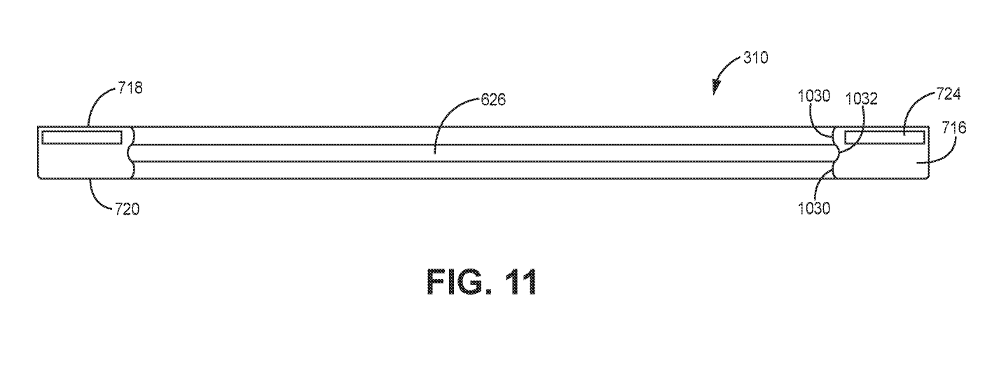

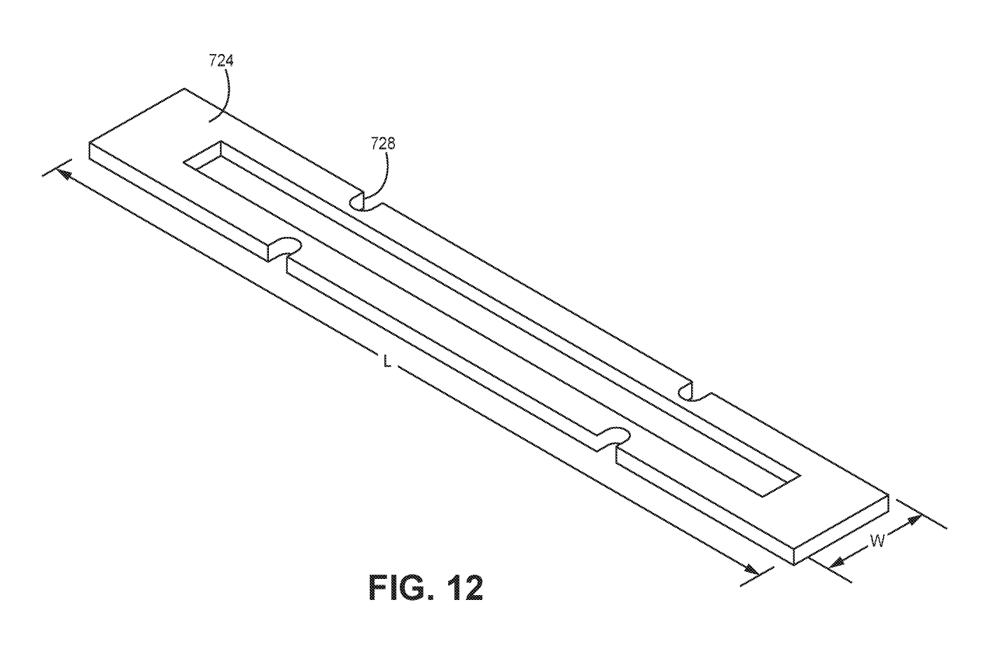

FIG. 10 is a cross section view of a seal 310, according to an embodiment. FIG. 11 is a cross section view of a seal 310 with a cross section taken perpendicular to the cross section shown in FIG. 10. As can be seen in FIGS. 10 and 11, in various embodiments, the seal 310 can include an insert 724 that is disposed within the seal body 716.

The inner surface 722 can define a portion of the gate aperture 626. The inner surface 722 can include at least one projection 1030 and at least one trough 1032, such as between the top surface 718 and the bottom surface 720. In an embodiment, the inner surface 722 can include two projections 1030 and one trough 1032, such as between the top surface 718 and the bottom surface 720. These projections 1030 and trough 1032 represent narrower and wider portions of the aperture 626 when a cross section is taken through the seal 310 so as to bisect the aperture 626 with a plane perpendicular to the top surface of the seal 310. A projection 1030 can refer to a portion of the inner surface 722 that extends into the gate aperture 626 when compared to the inner surface 722 at the top surface 718 or the bottom surface 720, such that the gate aperture 626 is narrower at a projection 1030. A trough 1032 can refer to a portion of the inner surface 722 that recesses away from the gate aperture 626 when compared to the inner surface 722 at the top surface 718 or the bottom surface 720.

In an embodiment, the inner surface 722 can include a trough 1032 between two projections 1030. In an embodiment, the trough 1032 can be centered or located halfway between the top surface 718 and the bottom surface 720. In an embodiment, the inner surface can have a sinusoidal shape.

FIG. 12 is a perspective view of an insert, according to an embodiment. In an embodiment, the insert 724 can have a length L of about 12.9 inches. In an embodiment, the seal 310 can have a length of at least 12 inches and not more than 13.5 inches. In an embodiment, the insert 724 can have a length of at least 10 inches and not more than 15 inches. In an embodiment, the insert 724 can have a length of at least 8 inches and not more than 17 inches. In an embodiment, the insert 724 can have a length of at least 6 inches and not more than 20 inches. In an embodiment, the insert 724 can have a length of at least 6 inches and not more than 30 inches.

In an embodiment, the insert 724 can have a width W of about 1.75 inches. In an embodiment, the insert 724 can have a width of at least 1.7 inches and not more than 1.8 inches. In an embodiment, the insert 724 can have a width of at least 1.6 inches and not more than 1.9 inches. In an embodiment, the insert 724 can have a width of at least 1.5 inches and not more than 2 inches. In an embodiment, the insert 724 can have a width of at least 1 inch and not more than 2.5 inches. In an embodiment, the insert 724 can have a width of at least 0.75 inches and not more than 3 inches. In an embodiment, the insert 724 can have a width of at least 0.75 inches and not more than 5 inches.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the technology.

1. A seal for a knife gate valve, comprising:
a seal body that comprises a top surface and a bottom surface, an inner surface of the seal body defines a gate aperture extending from the top surface to the bottom surface; and
an insert disposed within the seal body, wherein the insert extends around at least a portion of the gate aperture and the insert is more rigid than the seal body;
wherein the inner surface is nonlinear with at least one projection and at least one trough.

2. The seal for a knife gate valve according to claim 1, wherein the seal body defines at least one connector location.

3. The seal for a knife gate valve according to claim 1, wherein the seal body and insert define at least one connector location.

4. The seal for a knife gate valve according to claim 2, wherein the insert is completely surrounded by the seal body except for at any connector locations.

5. The seal for a knife gate valve according to claim 1, wherein over 90% but less than 100% of the insert is surrounded by the seal body.

6. The seal for a knife gate valve according to claim 1, wherein the insert comprises metal and the seal body comprises rubber or a polymer.

7. The seal for a knife gate valve according to claim 1, wherein the at least one trough is positioned between two projections.

8. The seal for a knife gate valve according to claim 1, wherein the trough is centered between the top surface and the bottom surface.

9. The seal for a knife gate valve according to claim 1, wherein the seal body is a substantially rectangular prism.

10. The seal for a knife gate valve according to claim 1, wherein the inner surface exhibits a sinusoidal shape.

11. A knife gate valve, comprising:
a valve body that defines a flow aperture, the valve body configured to be coupled to a conduit;
a gate disposed at least partially within the valve body, the gate configured to be moved vertically in relation to the valve body from a lowered position to a raised position, wherein when the gate is in a lowered position the gate substantially terminates flow through the flow aperture and when the gate is in a raised position flow is permitted through the flow aperture;
a seal disposed on top of the valve body; the seal comprises:
a seal body comprises a top surface, a bottom surface, and an inner surface, wherein the inner surface defines a gate aperture extending from the top surface to the bottom surface; and
an insert disposed within the seal body, wherein the insert extends around at least a portion of the gate aperture and the insert is more rigid than the seal body;
wherein at least a portion of the gate moves through the gate aperture when the gate is moved from the raised position to the lowered position or from the lowered position to the raised position.

12. The knife gate valve according to claim 11, wherein inner surface is nonlinear with at least one projection and at least one trough.

13. The knife gate valve according to claim 11, wherein the seal body defines at least one connector location.

14. The knife gate valve according to claim 11, wherein the seal body and insert define at least one connector location.

15. The knife gate valve according to claim 13, wherein the insert is completely surrounded by the seal body except for at any connector locations.

16. The knife gate valve according to claim 11, wherein over 90% of the insert is surrounded by the seal body.

17. The knife gate valve according to claim 11, wherein the insert comprises metal and the seal body comprises rubber or a polymer.

18. The knife gate valve according to claim 12, wherein the at least one trough is positioned between two projections.

19. The knife gate valve according to claim 12, wherein the trough is centered between the top surface and the bottom surface.

20. A knife gate valve, comprising:
a valve body that defines a flow aperture, the valve body configured to be coupled to a conduit;
a gate disposed at least partially within the valve body, the gate configured to be moved vertically in relation to the valve body from a lowered position to a raised position, wherein when the gate is in a lowered position the gate substantially terminates flow through the flow aperture and when the gate is in a raised position flow is permitted through the flow aperture;
a flexible seal coupled to the valve body, wherein flexible the seal comprises:
a seal body that comprises:
a substantially flat top surface,
a substantially flat bottom surface, and
an inner surface that a gate aperture extending from the top surface to the bottom surface; and
a metallic insert disposed within the flexible seal body, wherein the metallic insert extends around at least a portion of the gate aperture but does not form the gate aperature, and the insert is more rigid than the seal body;
wherein a cross section of the inner surface taken from the top to the bottom of the seal body has a non-linear contact with at least one projection and at least one trough such that the open area defined by the inner surface is greater intermediate the top surface and bottom surface than it is intermediate the top and bottom surface;
wherein at least a portion of the gate moves through the gate aperture when the gate is moved from the raised position to the lowered position or from the lowered position to the raised position;
wherein the insert is completely surrounded by the flexible seal body except for at any connector locations on the top surface of the seal body; and
wherein over 90% of the insert is surrounded by the flexible seal body.
